(19) United States
(12) Patent Application Publication
(10) Pub. No.: US 2019/0195437 A1
(43) Pub. Date: Jun. 27, 2019

(54) LED LAMP BASE AND LED BULB

(71) Applicant: SENGLED OPTOELECTRONICS CO., LTD, Tongxiang (CN)

(72) Inventors: Shumin TANG, Tongxiang (CN); Shuyu CAO, Tongxiang (CN)

(21) Appl. No.: 16/327,887

(22) PCT Filed: Aug. 30, 2017
(86) PCT No.: PCT/CN2017/099604

§ 371 Date: Feb. 25, 2019

(30) Foreign Application Priority Data
Aug. 31, 2016 (CN) 201610793899.6

(51) Int. Cl. F21K 9/238; F21K 9/235

(52) U.S. Cl. CPC F21K 9/238; F21Y 2115/10; F21K 9/235

(57) ABSTRACT

The present disclosure provides an LED lamp base and an LED bulb. The LED lamp base comprises a housing, a printed circuit board, and a common mode coil. The common mode coil is disposed on the PCB. A first groove and a second groove are configured in an inner wall of the housing. A first end of the PCB is slid in the first groove, and a second end of the PCB is slid in the second groove. A thickness of the first groove and a thickness of the second groove are matched with a thickness of the PCB. By configuring the common mode coil in the LED lamp base, the impact of a change in the inductance coefficient may be avoided, thus ensuring an ability of the common mode coil in reducing the electromagnetic interference.

### CROSS-REFERENCES TO RELATED APPLICATIONS

This application is a national phase entry under 35 U.S.C. § 371 of International Application No. PCT/CN2017/099604, filed on Aug. 30, 2017, which claims the priority of Chinese Patent Application No. 201610793899.6 filed on Aug. 31, 2016, the entire content of both of which is incorporated herein by reference.

### FIELD OF THE DISCLOSURE

The present disclosure relates to the illumination technology and, more particularly, relates to an LED lamp base and an LED bulb.

### BACKGROUND

The common mode coil is often applied to the design of a printed circuit board (PCB) and has a wave-filtering function of electromagnetic interference, which may be configured to reduce the outgoing radiation of the electromagnetic wave generated by the high-speed signal line. In the design of the light-emitting diode (LED), the common mode coil may be used to reduce electromagnetic interference.

### BRIEF SUMMARY OF THE DISCLOSURE

The present disclosure provides an LED lamp base and an LED bulb, configured to solve the issue that the LED bulbs in existing technologies often impair the common mode coil's function to correct electromagnetic interference.

A first aspect of the present disclosure provides an LED lamp base, comprising: a housing, a printed circuit board (PCB), and a common mode coil.

The common mode coil is disposed on the PCB.

A first groove and a second groove are configured in an inner wall of the housing, a first end of the PCB is slid onto the first groove, and a second end of the PCB is slid into the second groove.

A thickness of the first groove and a thickness of the second groove may be matched with the thickness of the PCB, respectively.

In one embodiment, the LED lamp base further includes: a first live wire, a first neutral wire, a second live wire, and a second neutral wire.

A first end of the common mode coil may be connected to the first live wire, a second end of the common mode coil may be connected to the first neutral wire, a third end of the common mode coil may be connected to the second live wire, and a fourth end of the common mode coil may be connected to the second neutral wire.

The common mode coil may be connected to a drive power board of the LED bulb via the first live wire and the first neutral wire, and the second live wire and the second neutral wire may be welded to the LED lamp base, respectively.

In one embodiment, the PCB may include a first zone. The first zone may be an area undergoes a metallic clearance process.

In one embodiment, the first zone may include a plurality of sub-zones. Each sub-zone may use an edge of the PCB as a starting line, and a width of each sub-zone may be a preset width.

In one embodiment, the first zone may include three sub-zones. The starting lines of the three sub-zones may be an edge in contact with the first groove and the second groove, and two edges that are adjacent to the edge in contact with the first groove and the second groove, respectively.

In one embodiment, the LED lamp base may further include a first gasket and a second gasket.

The first gasket and the second gasket are disposed on an inner wall of the housing, respectively, and grooves are configured in the first gasket and the second gasket, respectively. A third end and a fourth end of the PCB may be respectively slid into the groove of the first gasket and onto the groove of the second gasket.

In one embodiment, the first zone may include four sub-zones. The starting lines of the four sub-zones may be four edges of the PCB, respectively.

In one embodiment, the first groove and the second groove may be configured in the vitreous body medium in bottom of the LED lamp base.

A second aspect of the present disclosure provides an LED bulb, comprising a bulb body and the aforementioned LED lamp base.

A third aspect of the present disclosure provides an LED bulb, comprising a bulb body and an LED lamp base. The LED lamp base may be any suitable aforementioned LED lamp base.

Further, a third groove and a fourth groove may be configured in the inner wall of the bulb body.

The third end and the fourth end of the PCB in the LED bulb may be slid inside the third groove and the fourth groove, respectively.

In the LED lamp base and the LED bulb provided by the present disclosure, by configuring the common mode coil inside the LED lamp base, the impact of the change in the inductance coefficient may be avoided, thereby ensuring the common mode coil capacity to correct electromagnetic interference.

### BRIEF DESCRIPTION OF THE DRAWINGS

To more clearly illustrate the technical solutions in embodiments of the present disclosure or the prior art, the accompanying drawings needed in descriptions of the present disclosure or the prior art are briefly introduced hereinafter. Obviously, the accompanying drawings described hereinafter are merely some embodiments of the present disclosure. For those ordinarily skilled in the relevant art, other drawings may be derived from the accompanying drawings without creative effort.

FIG. 1 illustrates a structural schematic view of an LED bulb consistent with various disclosed embodiments;

FIG. 2 illustrates a structural schematic view of an LED lamp base consistent with Embodiment 1;

FIG. 3 illustrates a structural schematic view of an LED lamp base consistent with Embodiment 2;

FIG. 4 illustrates a structural schematic view of an LED lamp base consistent with Embodiment 3;

FIG. 5 illustrates a structural schematic view of an LED lamp base consistent with Embodiment 4; and

FIG. 6 illustrates a structural schematic view of an LED bulb consistent with Embodiment 1.

The reference numerals in the accompanying drawings:
1: Lamp base;
2. Bulb body;
21: Third groove;
22: Fourth groove;
3: PCB of bulb body;
4: Housing;
41: First groove;
42: Second groove;
5: PCB;
51: First zone;
6: Common mode coil;
7: First live wire;
8: First neutral wire;
9: Second live wire;
10: Second neutral wire;
11: First gasket;
12: Second gasket.

### DETAILED DESCRIPTION

To make the objective, technical solutions and advantages of the present disclosure clearer, technical solutions in embodiments of the present disclosure will be described in a clear and complete manner hereinafter with reference to the accompanying drawings in embodiments of the present disclosure. Obviously, the embodiments described herein are merely a part of, but not entire embodiments of the present disclosure. Based on the embodiments of the present disclosure, other embodiments obtainable by those ordinarily skilled in the art without creative effort shall all fall within the protection scope of the present disclosure.

When designing the LED bulb, the electronic elements and the PCB may be disposed inside the bulb. To solve the issue of heat dissipation, glue may be filled in the bulb. With regard to the filled glue, the content of aluminum oxide is as high as 70%, and the content of polysiloxane may reach 25%. The dielectric constant of the glue is high. Further, the inductance is related to the inductance coefficient and the square of the number of turns of the common mode coil, and the inductance coefficient is related to the cross-sectional area of the magnetic core, the length of the magnetic circuit, and the magnetic conductivity of the entire magnetic circuit loop. Accordingly, glue filling in the body of the bulb may change the inductance coefficient of the material of the magnetic core, thus resulting in a change in the inductance. Therefore, the correction ability of the common mode coil towards electromagnetic interference may be reduced.

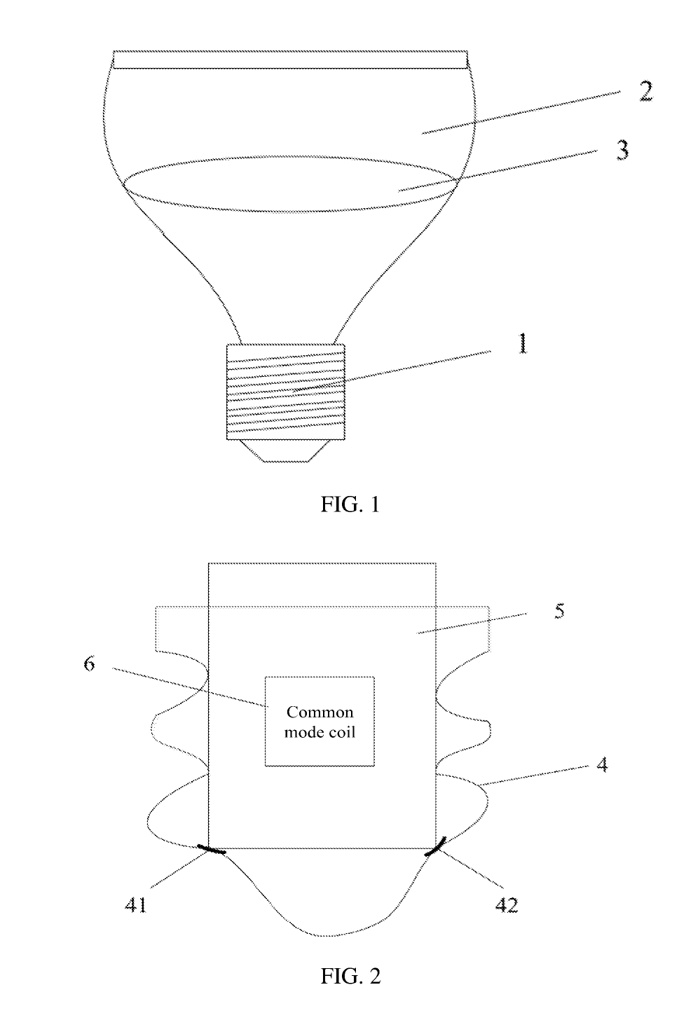

FIG. 1 illustrates a structural schematic view of an LED bulb consistent with various disclosed embodiments. As shown in FIG. 1, the LED bulb may include a lamp base 1 and a bulb body 2. A bulb body PCB 3 may be disposed inside the bulb body 2. The bulb body PCB 3 may be a drive power board of the LED bulb. In existing technologies, a common mode coil may be disposed in the bulb body PCB 3, and when a glue fills the bulb body, because the inductance coefficient changes, the common mode coil capacity to correct electromagnetic interference may be impaired.

Directed to addressing the aforementioned issues, the present disclosure provides an LED lamp base and an LED bulb. By configuring the common mode coil in the LED lamp base, the impact of a change in the inductance coefficient may be reduced, thereby ensuring the common mode coil function to correct the electromagnetic interference is not impaired.

FIG. 2 illustrates a structural schematic view of an LED lamp base consistent with Embodiment 1. As shown in FIG. 2, the LED lamp base may include a housing 4, a PCB 5, and a common mode coil 6.

The common mode coil 6 may be disposed on the PCB 5.

A first groove 41 and a second groove 42 may be configured in an inner wall of the housing 4, a first end of the PCB 5 may be slid inside the first groove 41, and a second end of the PCB 5 may be slid inside the second groove 42.

More specifically, the first groove 41 and the second groove 42 may be disposed on the vitreous body medium in the bottom of the aforementioned LED lamp base, thereby having a function of fixing the PCB 5.

Preferably, the thickness of the first groove 41 may be matched with the thickness of the second groove 42, and the thickness of the second groove 42 may be matched with the thickness of the PCB 5, such that the PCB 5 is ensured to be fixed into the housing 4.

It should be noted that, the PCB 5 may be a PCB disposed in the LED lamp base, and is independent with respect to the bulb body PCB 3 disposed in the LED bulb body shown in FIG. 1.

The aforementioned LED lamp base may be applied to the LED bulb, and when the LED bulb is in operation, because the common mode coil 6 is disposed in the LED lamp base, even though glue is filled in the LED bulb body, the ability of the common mode coil 6 in reducing the electromagnetic interference generated by the high-speed signal line may not be affected.

In one embodiment, by configuring the common mode coil in the LED lamp base, the impact of a change in the inductance coefficient may be reduced, and capacity of the common mode coil to reduce the electromagnetic interference may be maintained. Further, by sliding two ends of the PCB in the grooves of the housing, the PCB may be ensured to be fixed in the housing.

Further, when the disclosed LED lamp base undergoes LED lamp base debugging, only the LED lamp base may need to be dismounted. That is, the housing of the LED bulb body does not need to be damaged, and disconnection and re-assembly are also not needed. Accordingly, the debugging of the LED lamp base may be relatively easy and feasible, thereby improving the efficiency and the accuracy of the LED lamp base debugging.

Further, in the disclosed LED lamp base, by disposing the common mode coil in the LED lamp base, the utilization of the LED lamp base may be improved. Further, the common mode coil may be separated from the PCB of the LED light body, thus saving the space inside the bulb body and the layout space of the PCB in the LED bulb body. Accordingly, the requirements of a small volume of the illumination device may be satisfied.

FIG. 3 illustrates a structural schematic view of an LED lamp base consistent with Embodiment 2. As shown in FIG. 3, the aforementioned LED lamp base may further include: a first live wire 7, a first neutral wire 8, a second live wire 9, and a second neutral wire 10.

More specifically, a first end of the common mode coil 6 may be connected to the first live wire 7, a second end of the common mode coil 6 may be connected to the first neutral wire 8, a third end of the common mode coil 6 may be connected to the second live wire 9, and a fourth end of the common mode coil 6 may be connected to the second neutral wire 10.

The common mode coil 6 may be connected to the drive power board of the LED bulb via the first live wire 7 and the first neutral wire 8, and the second live wire 9 and the second neutral wire 10 may be welded to the aforementioned LED lamp base, respectively.

More specifically, because the common mode coil 6 may be connected to the drive power board of the LED bulb via the first live wire 7 and the first neutral wire 8, and the second live wire 9 and the second neutral wire 10 may be welded to the aforementioned LED lamp base, respectively, the drive power board of the LED bulb may be connected to the LED lamp base. Thus, the normal connection between the LED lamp base and the drive power board of the LED bulb after the PCB and the common mode coil are configured inside the LED lamp base may be ensured. Accordingly, the LED bulb may operate normally.

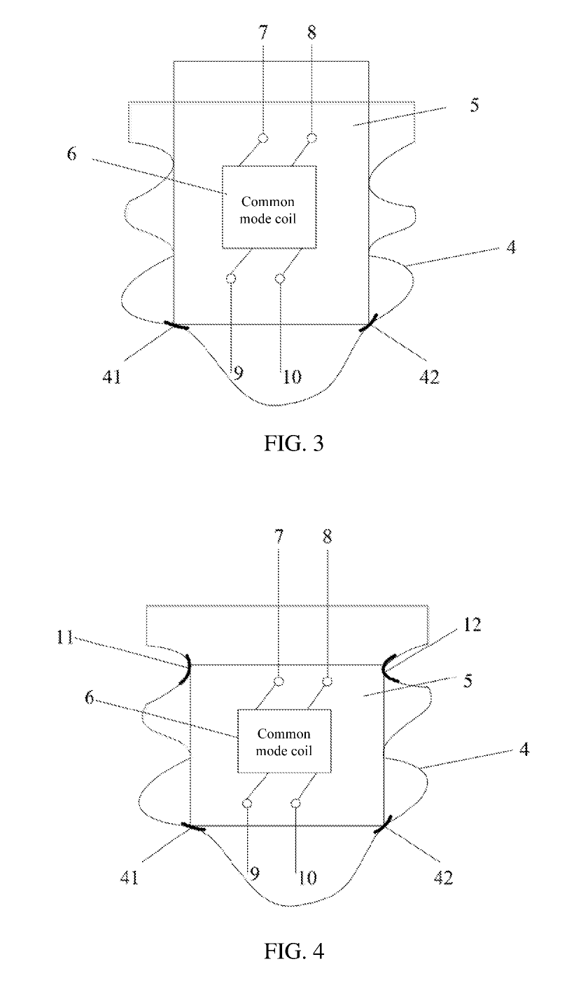

FIG. 4 illustrates a structural schematic view of an LED lamp base consistent with Embodiment 3. As shown in FIG. 4, the aforementioned LED lamp base may further include a first gasket 11 and a second gasket 12.

The first gasket 11 and the second gasket 12 may be disposed on the inner wall of the housing 4, respectively. A groove is disposed in the first gasket 11 and the second gasket 12, respectively. A third end and a fourth end of the PCB 5 may be slid in the groove of the first gasket 11 and the groove of the second gasket 12.

More specifically, the positions of the first gasket 11 and the second gasket 12 in the housing may be relative to the first groove 41 and the second groove 42. That is, the first gasket 11 and the second gasket 12 may be located on the top portion of the housing 4. Further, a distance between the first gasket 11 and the first groove 41 may be equal to the length of the PCB 5, such that the two ends of the PCB 5 may be slid in the first groove 41 and the groove of the first gasket 11. A distance between the second gasket 12 and the second groove 42 may be equal to the length of the PCB 5, such that two ends of the PCB 5 may be slid in the second groove 42 and the groove of the second gasket 12, respectively. Further, the thicknesses of the first gasket 11 and the second gasket 12 may be configured flexibly based on the dimension of the PCB 5 to ensure the firmness of position of the PCB 5.

In one embodiment, by disposing gaskets onto the housing of the LED lamp base and configuring grooves in the gaskets, the third end and the fourth end of the PCB may be slid in such grooves. Accordingly, the configuration firmness of the PCB on the LED lamp base may be further ensured.

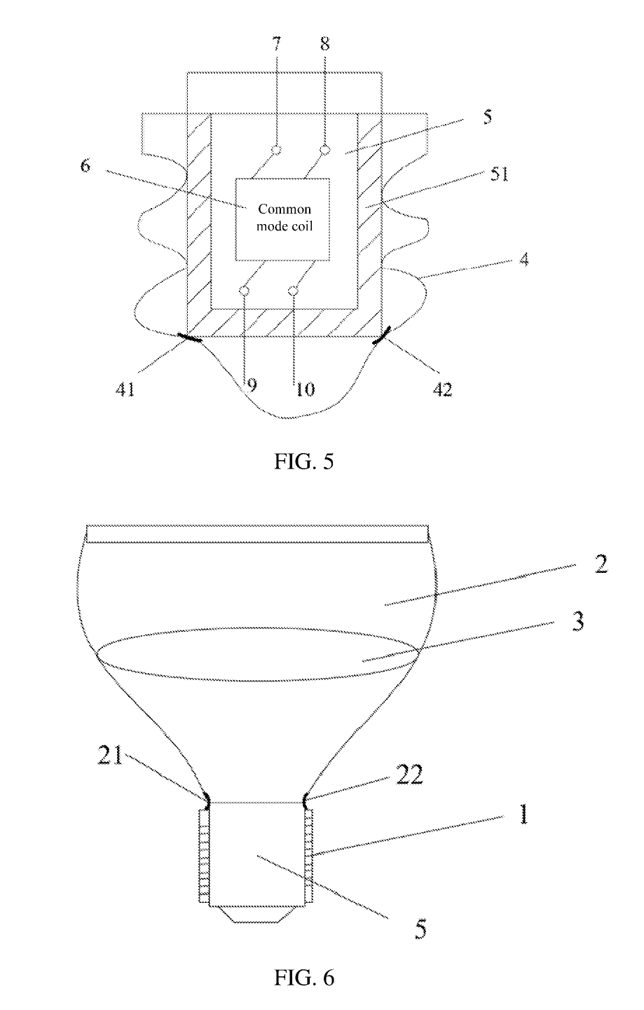

FIG. 5 illustrates a structural schematic view of an LED lamp base consistent with Embodiment 4. As shown in FIG. 5, the PCB 5 may include a first zone 51, and the first zone 51 may be a zone undergoes a metallic clearance process.

More specifically, the first zone 51 may include a plurality of sub-zones. Each sub-zone may use an edge of the PCB 5 as a starting line, and a width of each sub-zone is a preset width.

Referring to FIG. 5, the first zone may include three sub-zones. The starting lines of the three sub-zones may include an edge (of the first zone) in contact with both the first groove and the second groove, and two edges adjacent to the edge that is in contact with the first groove and the second groove. That is, the first zone may be a slant area illustrated in FIG. 5, and may be divided into three sub-zones each with a preset width starting from a left edge, a right edge and a lower edge of the first zone, respectively. In such sub-zones, the metal on the PCB board such the copper foil may need to undergo the clearance process, thereby ensuring the safety of the LED lamp base.

Under another condition, for example, the situation illustrated in FIG. 4, the upper edge of the PCB 5 may also be located inside the LED lamp base. Accordingly, under such situation, the sub-zone with a preset width starting from the upper edge of the PCB 5 may also need to undergo the clearance process. That is, under the situation shown in FIG. 4, the first zone may include four sub-zones, and the starting lines of the four sub-zones may be four edges of the PCB, respectively.

Optionally, the width of each aforementioned sub-zone may be 2.5 mm.

The present disclosure further provides an LED bulb. The LED bulb may include a bulb body and the aforementioned LED lamp base. The entire structure of the LED bulb may refer to FIG. 1. In one embodiment, the mounting method of the LED lamp base in the LED bulb may be the gasket configuration manner described in FIG. 4.

In another embodiment, different from the aforementioned gasket configuration method, the third end and the fourth end of the PCB 5 in the LED lamp base of the LED bulb may be fixedly attached inside the bulb body of the LED bulb. More specifically, FIG. 6 illustrates a structural schematic view of an LED bulb consistent with Embodiment 1. As shown in FIG. 6, a third groove 21 and a fourth groove 22 may be disposed on the inner wall of the bulb body 2.

The third end and the fourth end of the PCB 5 in the LED lamp base may be slid in the third groove 21 and the fourth groove 22, respectively.

Preferably, the third groove 21 and the fourth groove 22 may be specifically configured in the groove along the edge of the housing of the bulb body, thereby implementing the fixation of the PCB 5.

In one embodiment, the lamp base of the LED bulb may be the aforementioned LED lamp base. Accordingly, the issue that the ability of the common mode coil in reducing the electromagnetic interference being impaired may be solved, and the normal operation of the LED bulb may be ensured.

Finally it should be illustrated that, the above-described embodiments are used to illustrate technical solutions of the present disclosure, but not to limit the present disclosure. Though the present disclosure is illustrated in detail with reference to the aforementioned embodiments, those ordinarily skilled in the art may shall understand that technical solutions in the present disclosure may still be modified, or partial or entire technical characteristics may be equivalently replacement. Such modification or replacement, without departing from the spirit of the present disclosure, shall all fall within the scope of the present disclosure.

1. An LED lamp base, comprising a housing, a printed circuit board, and a common mode coil, wherein:
the common mode coil is disposed on the printed circuit board;
a first groove and a second groove are configured in an inner wall of the housing, a first end of the printed circuit board is disposed in the first groove, and a second end of the printed circuit board is disposed in the second groove; and
a thickness of the first groove and a thickness of the second groove are respectively matched with a thickness of the PCB.

2. The LED lamp base according to claim 1, further comprising a first live wire, a first neutral wire, a second live wire, and a second neutral wire, wherein:
a first end of the common mode coil is connected to the first live wire, a second end of the common mode coil is connected to the first neutral wire, a third end of the common mode coil is connected to the second live wire, and a fourth end of the common mode coil is connected to the second neutral wire; and
the common mode coil is connected to an LED bulb drive power board via the first live wire and the first neutral wire, and the second live wire and the second neutral wire are welded to the LED lamp base, respectively.

3. The LED lamp base according to claim 1, wherein:
the PCB comprises a first zone, and the first zone is a zone undergoes a metallic clearance process; and
the first zone comprises a plurality of sub-zones, and each sub-zone uses an edge of the PCB as a starting line.

4. The LED lamp base according to claim 3, wherein:
the first zone comprises three sub-zones, and starting lines of the three sub-zones include an edge that is in contact with the first groove and the second groove and two edges adjacent to the edge that is in contact with the first groove and the second groove.

5. The LED lamp base according to claim 3, further comprising a first gasket and a second gasket, wherein:
the first gasket and the second gasket are disposed on an inner wall of the housing, a groove is configured in the first gasket and the second gasket, respectively, and a third end and a fourth end of the PCB are disposed in the groove of the first gasket and the groove of the second gasket.

6. The LED lamp base according to claim 3, wherein:
the first zone comprises four sub-zones, and starting lines of the four sub-zones are four edges of the PCB, respectively.

7. The LED lamp base according to claim 1, wherein:
the first groove and the second groove are disposed on a vitreous body in a bottom of the LED lamp base.

8. An LED bulb, comprising:
a bulb body and an LED lamp base according to claim 1.

9. An LED bulb comprising a bulb body and an LED lamp base, the LED lamp base further comprising a housing, a printed circuit board, and a common mode coil, wherein:
the common mode coil is disposed on the printed circuit board;
a first groove and a second groove are configured in an inner wall of the housing, a first end of the printed circuit board is disposed in the first groove, and a second end of the printed circuit board is disposed in the second groove; and
a thickness of the first groove and a thickness of the second groove are matched with a thickness of the PCB.

10. The LED bulb according to claim 9, wherein:
a third groove and a fourth groove are configured in an inner wall of the bulb body, and
a third end and a fourth end of the PCB in the LED lamp base are disposed in the third groove and the fourth groove.
